(19) United States
(12) Patent Application Publication
(10) Pub. No.: US 2022/0094006 A1
(43) Pub. Date: Mar. 24, 2022

(54) HIGH-VOLTAGE BATTERY PACK FOR VEHICLE

(71) Applicants: HYUNDAI MOTOR COMPANY, Seoul (KR); KIA MOTORS CORPORATION, Seoul (KR)

(72) Inventors: Gyung Hoon SHIN, Seoul (KR); Yong Hwan CHOI, Seoul (KR); Yu Ri OH, Hwaseong-si (KR); Tae Hyuck KIM, Asan-si (KR); Hae Kyu LIM, Bucheon-si (KR); Ji Woong JUNG, Anyang-si (KR)

(73) Assignees: HYUNDAI MOTOR COMPANY, Seoul (KR); KIA MOTORS CORPORATION, Seoul (KR)

(21) Appl. No.: 17/187,406

(22) Filed: Feb. 26, 2021

(30) Foreign Application Priority Data
Sep. 24, 2020 (KR) 10-2020-0124107

(51) Int. Cl. H01M 50/242; B60L 50/60; H01M 50/249

(52) U.S. Cl. CPC H01M 50/242; H01M 2220/20; H01M 50/249; B60L 50/60

(57) ABSTRACT

A high-voltage battery pack for a vehicle includes: an upper case; a lower case; a plurality of battery modules mounted on the lower case; a busbar disposed on an upper side of the plurality of battery modules and electrically connecting the plurality of battery modules; and a plurality of first elastic pads coupled to the busbar.

### CROSS-REFERENCE TO RELATED APPLICATION

This application claims priority to and the benefit from Korean Patent Application No. 10-2020-0124107, filed on Sep. 24, 2020, the entire contents of which are incorporated herein by reference.

### FIELD

The present disclosure relates to a high-voltage battery pack for a vehicle.

### BACKGROUND

The statements in this section merely provide background information related to the present disclosure and may not constitute prior art.

Hybrid electric cars, fuel cell cars, electric cars, and environmentally-friendly cars are all configured to use electric motors to be driven, and thus are equipped with high-voltage battery packs for providing driving power to the electric motors.

A high-voltage battery pack commonly includes a battery case, multiple battery modules mounted inside the battery case, and a battery management system (BMS) for sensing the voltage, current, temperature, and the like of respective unit cells constituting the battery modules and controlling operations thereof.

The battery case includes an upper case and a lower case. The multiple battery modules, the BMS, and the like are mounted inside the lower case, and the upper case covers the lower case in which the multiple battery modules, the BMS, and the like are mounted.

In addition, each battery module includes multiple battery cells stacked on each other, a pair of end plates coupled to the left/right sides of the stacked battery cells so as to protect the battery cells, and a pair of sensing blocks coupled to the front/rear sides of the stacked battery cells so as to electrically connect the battery cells to each other.

Meanwhile, in line with increasing high-end vehicles having improved performance, batteries are desired to have increased energy capacities. This in turn increases the battery size, and an increased amount of batteries are desired.

If a large number of batteries are mounted in the limited space of the battery case in order to meet the energy requirement in this manner, we have discovered that an existing scheme may not be sufficient for securing the durability (NVH) of the entire high-voltage battery pack and for securing safety against collisions.

The above descriptions regarding background arts are only for helping understanding of the background of the present disclosure, and are not to be considered by a person skilled in the art as corresponding to already-known prior arts.

### SUMMARY

The present disclosure provides a high-voltage battery pack for a vehicle, including multiple elastic pads applied to a battery case and a busbar, and multiple members applied to a lower case, thereby securing the durability of the entire high-voltage battery pack and securing safety against collisions.

One form of the present disclosure provides a high-voltage battery pack for a vehicle, including: an upper case; a lower case; and a plurality of battery modules mounted on the lower case. The high-voltage battery pack may further include: a busbar disposed on the upper side of the battery modules and electrically connecting the battery modules; and a plurality of first elastic pads coupled to the busbar.

Each of the battery modules may include: a top cover covering the upper side of battery cells that are stacked; and end plates disposed to cover the left and right sides of the battery cells. The first elastic pads may be coupled to be disposed at upper ends of the top covers or upper ends of the end plates.

The high-voltage battery pack may further include: a plurality of second elastic pads coupled to an upper surface on the outside of the upper case. Some of the second elastic pads may overlap the first elastic pads on the same plane.

The high-voltage battery pack may further include: a plurality of second elastic pads coupled to an upper surface on the outside of the upper case. Some of the second elastic pads may be surface-attached to a vehicle body or components connected to the vehicle body.

The high-voltage battery pack may further include: an outer side member provided in the lower case and coupled to a vehicle body; and a plurality of third elastic pads disposed between the outer side member and the end plates of the battery modules.

The high-voltage battery pack may further include: a plurality of first cross members coupled to the lower case to extend forwards and rearwards; and a plurality of second cross members coupled to extend leftwards and rightwards. The battery modules mounted on the lower case may be installed to be connected to the plurality of first cross members and the plurality of second cross members.

The high-voltage battery pack may further include: a plurality of longitudinal members connecting second cross members disposed at a front periphery and a rear periphery of the lower case, and a front end and a rear end of the lower case, respectively.

Some of the longitudinal members may be connected to the end plates of the battery modules.

The high-voltage battery pack may further include: an outer side member provided in the lower case and coupled to a vehicle body. The outer side member, the first cross members, the second cross members, and the longitudinal members may form a load path against an external impact.

A high-voltage battery pack according to one form of the present disclosure is advantageous in that the NVH performance and durability can be improved by a first elastic pad coupled to a busbar, a second elastic pad coupled to an upper case, and a third elastic pad installed between an outer side member and an endplate of a battery module. Particularly, the third elastic pad can absorb side collision energy, thereby securing safety against side collision.

In addition, the high-voltage battery pack according to the present disclosure is advantageous in that the outer side member coupled to the lower case, first cross members, second cross members, and longitudinal members can reinforce strength and rigidity and, in particular, can function as a load path that delivers collision energy to the vehicle body during an accident, thereby improving durability.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a high-voltage battery pack for a vehicle according to the present disclosure, and is a view of a state in which an upper case is separated;

FIG. 2 is an exploded perspective view of a battery module;

FIG. 3 is a view illustrating a first elastic pad coupled to a busbar according to the present disclosure;

FIG. 4 is a cross-sectional view illustrating a first elastic pad coupled to the busbar and a second elastic pad coupled to an upper case according to the present disclosure;

FIG. 5 is a cross-sectional view illustrating a third elastic pad disposed between an outer side member of a lower case and an end plate of the battery module according to the present disclosure; and

FIG. 6 is a view illustrating first cross members, second cross members, and longitudinal members provided in the lower case according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A specific structural or functional description of various forms of the present disclosure disclosed in the specification or application is given merely for the purpose of describing the form according to the present disclosure. Therefore, the forms according to the present disclosure may be implemented in various forms, and the present disclosure should not be construed as being limited to the forms described in the specification or application.

Such terms as “a first” and/or “a second” may be used to described various elements, but the elements should not be limited by these terms. These terms are intended merely to distinguish one element from other elements. For example, a first element may be named a second element and similarly a second element may be named a second element without departing from the scope of protection of the present disclosure.

In the case where an element is referred to as being “connected” or “accessed” to other elements, it should be understood that not only the element is directly connected or accessed to the other elements, but also another element may exist between them. Contrarily, in the case where a component is referred to as being “directly connected” or “directly accessed” to any other component, it should be understood that there is no component therebetween. The other expressions of describing a relation between structural elements, i.e. “between” and “merely between” or “neighboring” and “directly neighboring”, should be interpreted similarly to the above description.

The terms used in the present disclosure are merely used to describe specific forms, and are not intended to limit the present disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure.

A control unit (controller) according to exemplary forms of the present disclosure may be implemented by a non-volatile memory (not shown) which is configured to store data pertaining to an algorithm configured to control operations of various vehicle components or software instructions for reproducing the algorithm, and a processor (not shown) which is configured to perform the operations as described below by using the data stored in the corresponding memory. Here, the memory and the processor may be implemented as individual chips. Alternatively, the memory and the processor may be implemented as an integrated single chip. The processor may be in the form of one or more processors.

Hereinafter, a high-voltage battery pack for a vehicle according to one form of the present disclosure will be described with reference to the accompanying drawings.

A vehicle that uses an electric motor as a driving source is essentially provided with a high-voltage battery pack that provides driving electric power to the electric motor.

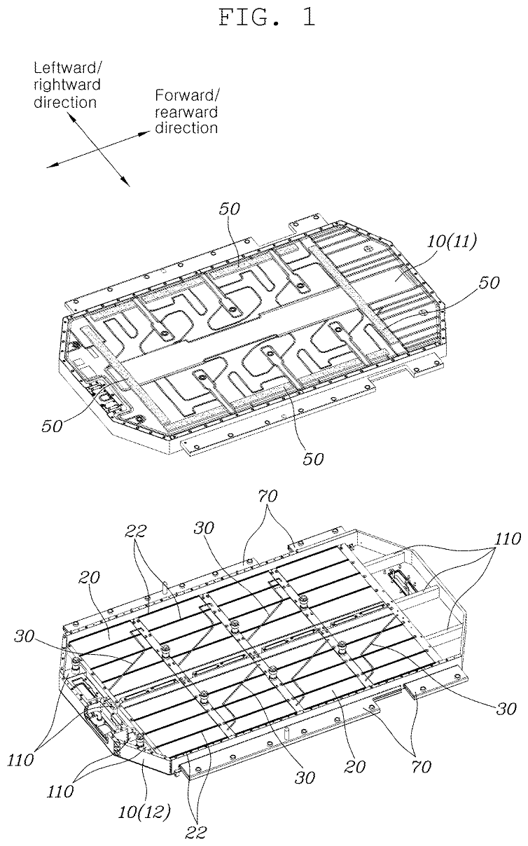

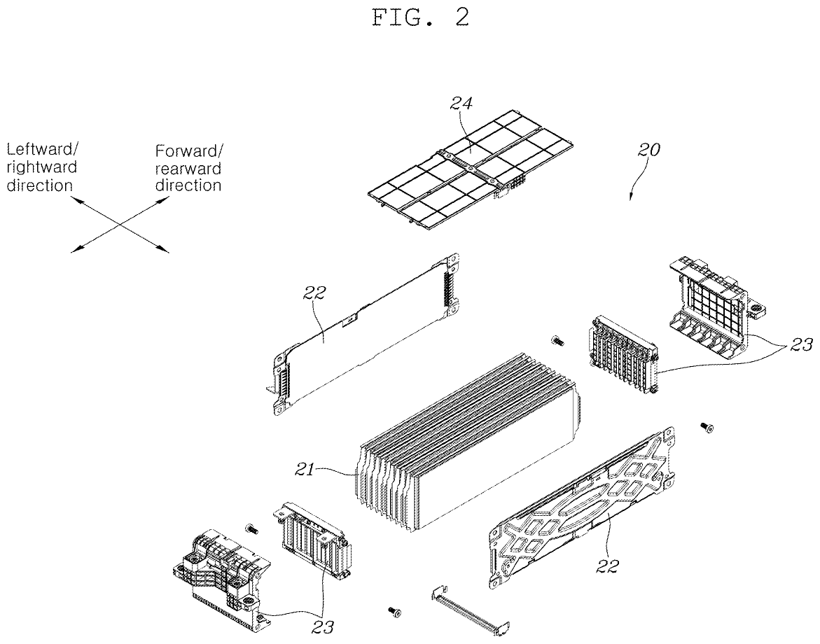

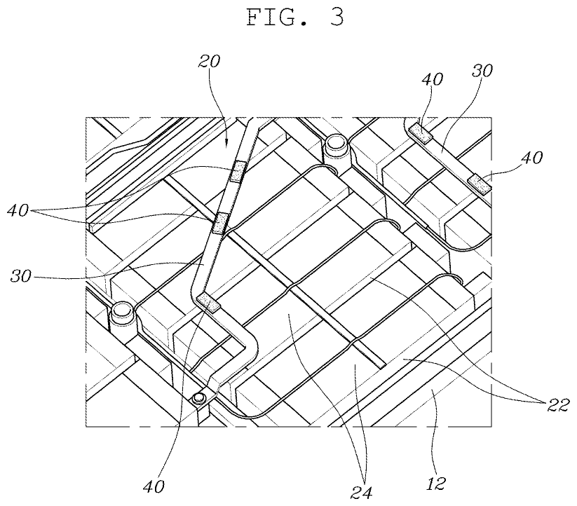

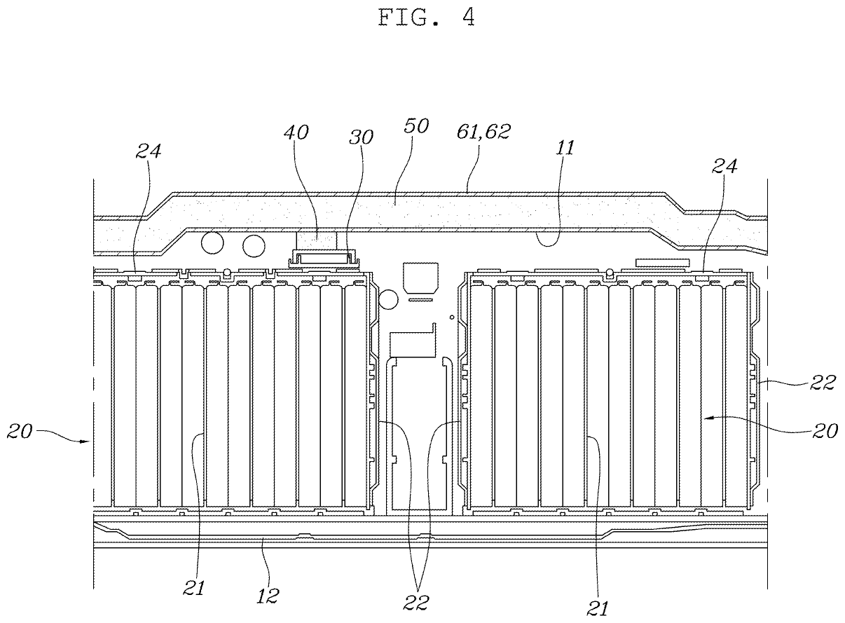

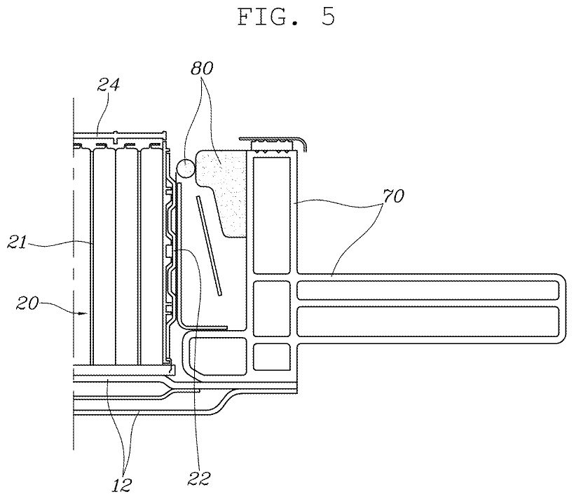

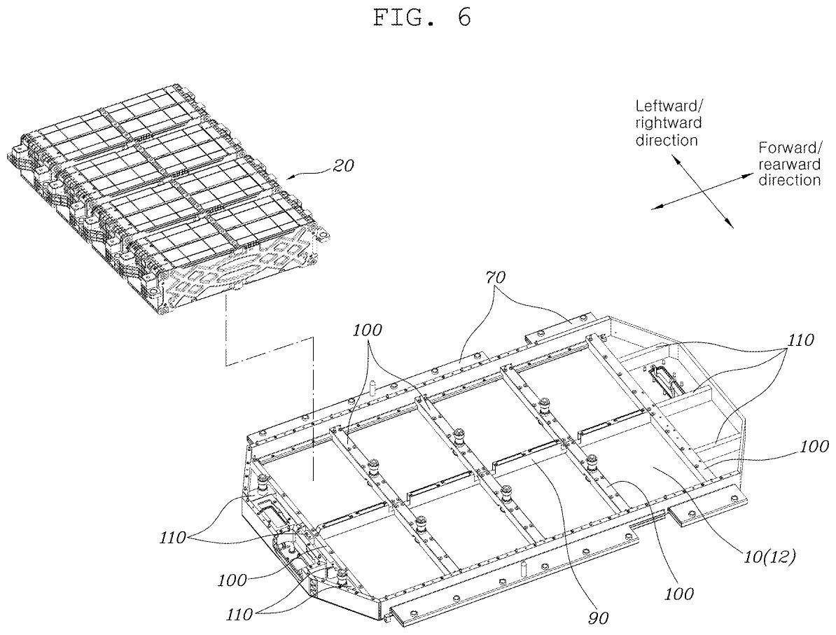

The high-voltage battery pack according to the present disclosure, as illustrated in FIGS. 1 to 6, includes a battery case 10, a plurality of battery modules 20 mounted on the battery case 10, and a battery management system (BMS) that detects the voltages, the currents, and the temperatures of respective unit cells constituting the battery modules 20 and controls the operations of the unit cells.

The battery case 10 includes an upper case 11 and a lower case 12, the plurality of battery modules 20, the BMS, and the like are mounted on the lower case 12, and the lower case 12, on which the battery modules 20 are mounted, is covered by the upper case 11.

Further, each of the battery modules 20 includes a plurality of stacked battery cells 21, a pair of end plates 22 coupled to the left and right sides of the stacked battery cells 21 to protect the battery cells 21, a pair of sensing blocks 23 coupled to the front and rear sides of the stacked battery cells 21 to electrically connect the battery cells 21, and a top cover 24 that covers the upper side of the stacked battery cells 21.

Two end plates 22 are disposed on the left and right sides to face each other while the stacked battery cells 21 are interposed therebetween, and are formed of rigid bodies to protect the battery cells 21 and control repulsive forces against swelling of the cells.

Two sensing blocks 23 are disposed on the front and rear sides to face each other while the stacked battery cells 21 are interposed therebetween, and function to electrically connect the battery cells 21.

The high-voltage battery pack 1 according to one form of the present disclosure further includes a busbar 30 disposed on the upper side of the battery modules 20 and electrically connecting the battery modules 20, and a plurality of first elastic pads 40 coupled to the busbar 30.

The first elastic pads 40 may be foiled of rubber or silicon having elasticity, and are fixedly coupled to the busbar 30 while being spaced apart from each other at a predetermined interval, and through this, noise vibration harshness (NVH) performance and durability can be improved.

For safe coupling of the first elastic pads 40, the first elastic pads 40 may be coupled to the busbar 30 to be disposed at upper ends of the top covers 24 constituting the battery modules 20 or upper ends of the end plates 22.

In addition, the high-voltage battery pack 1 according to one form of the present disclosure further includes a plurality of second elastic pads 50 coupled to an outer upper surface of the upper case 11.

The second elastic pads 50 may be formed of rubber or silicon having elasticity, and are fixedly coupled to an upper surface of the upper case 11 along the forward/rearward direction and the leftward/rightward direction, and through this, noise vibration harshness (NVH) performance and durability can be improved.

The second elastic pads 50 are located on the upper side of the first elastic pads 40 while the upper case 11 is interposed therebetween and some of the second elastic pads 50 may be located to overlap the first elastic pads 40 on the same plane, and through this, an effect of insulating vibration and noise can be further reinforced.

When the battery case 10 is coupled to and mounted on a vehicle body, some of the second elastic pads 50 are installed to surface-contact the vehicle body 61 or components 62 connected to the vehicle body, and through this, NVH performance and durability can be further improved.

Further, the high-voltage battery pack 1 according to one form of the present disclosure further includes an outer side member 70 provided in the lower case 12 and coupled to the vehicle body, and a plurality of third elastic pads 80 disposed between the outer side member 70 and the end plates 22 of the battery modules 20.

The outer side member 70 extends forwards and rearwards while being coupled to the left and right locations of the lower case 12.

The third elastic pads 80 may be formed of rubber or silicon having elasticity, and is fixed to the outer side member 70 to contact the end plates 22 of the battery modules 20, whereby NVH performance and durability can be improved, and in particular, the safety for a side collision can be secured as side collision energy can be absorbed.

In addition, the high-voltage battery pack 1 according to one form of the present disclosure further includes a plurality of first cross members 90 coupled to the lower case 12 to extend forwards and rearwards, and a plurality of second cross members 100 coupled to extend leftwards and rightwards.

The first cross members 90 are members installed to be parallel to the surfaces of the battery cells 21 mounted on the lower case 12, and the second cross members 100 are members installed in a direction that is perpendicular to the surfaces of the battery cells 21 mounted on the lower case 12.

The first cross members 90 and the second cross members 100 function to reinforce the strength and the rigidity of the lower case 12, and may function as a load path that delivers collision energy to the vehicle body during an accident, and through this, durability can be further improved.

The battery modules 20 mounted on the lower case 12 may be installed to be connected to the first cross members 90 and the second cross-members 100, and through this, the battery modules 20 can be installed more firmly and stably, whereby NVH performance and durability can be improved.

Further, the high-voltage battery pack 1 according to one form of the present disclosure further includes a plurality of longitudinal members 110 connecting the second cross members 100 disposed at a front periphery and a rear periphery of the lower case 12, and a front end and a rear end of the lower case 12, respectively.

The longitudinal members 110, together with the first cross members 90 and the second cross members 100, function to reinforce the strength and the rigidity of the lower case 12, and may function as a load path that delivers collision energy to the vehicle body during an accident, and through this, durability can be further improved.

Some of the longitudinal members 110 may be installed to be connected to the end plates 22 constituting the battery module 20, and through this, the battery modules 20 can be installed more firmly and stably, whereby NVH performance and durability can be improved.

The lower case 12 constituting the battery case 10 has a structure, in which a panel member constituting the floor, the above-described outer side member 70, the first cross members 90, the second cross members 100, and the plurality of longitudinal members 110 are coupled to each other, the outer side member 70 is installed to be coupled to the vehicle body 61, and the second elastic members 50 coupled to the upper case 11 surface-contact the vehicle body 61 or the components 62 connected to the vehicle body.

Accordingly, if the collision energy generated during a collision accident is delivered to the high-voltage battery pack 1 mounted on the vehicle, the outer side member 70, the first cross members 90, the second cross members 100, and the plurality of longitudinal members 110 form a load path, whereby collision energy can be delivered to the vehicle body to be dispersed, and through this, durability and the safety for a collision can be secured.

As described above, the high-voltage battery pack 1 according to one form of the present disclosure can improve NVH performance and durability through the first elastic pads 40 coupled to the busbar 30, the second elastic pads 50 coupled to the upper case 11, and the third elastic pads 80 installed between the outer side member 70 and the end plates 22 of the battery modules 20, and in particular, the safety for a side collision can be secured as the third elastic pads 80 can absorb side collision energy.

In addition, the strength and the rigidity of the high-voltage battery pack 1 according to the present disclosure can be reinforced by the outer side member 70 coupled to the lower case 12, the first cross members 90, the second cross members 100, and the longitudinal members 110, and in particular, the first cross members 90, the second cross members 100, and the longitudinal members 110 can function as a load path that delivers collision energy to the vehicle body during an accident, whereby durability can be improved.

Although the present disclosure has been described and illustrated in conjunction with particular forms thereof, it will be apparent to those skilled in the art that various improvements and modifications may be made to the present disclosure without departing from the technical idea of the present disclosure defined by the appended claims.

What is claimed is:

1. A high-voltage battery pack for a vehicle, the high-voltage battery pack comprising:
an upper case;
a lower case;
a plurality of battery modules mounted on the lower case;
a busbar disposed on an upper side of the plurality of battery modules and configured to electrically connect battery modules of the plurality of battery modules; and
a plurality of first elastic pads coupled to the busbar.

2. The high-voltage battery pack of claim 1, wherein each battery module of the plurality of battery modules comprises:
a top cover covering an upper side of battery cells that are stacked on one another; and
end plates configured to cover left and right sides of the battery cells,
wherein the plurality of first elastic pads are configured to be disposed at upper ends of the top covers or at upper ends of the end plates.

3. The high-voltage battery pack of claim 1, further comprising:
a plurality of second elastic pads coupled to an upper surface on the outside of the upper case,
wherein at least one second elastic pad of the plurality of second elastic pads overlaps the plurality of first elastic pads on a same plane.

4. The high-voltage battery pack of claim 1, further comprising:
a plurality of second elastic pads coupled to an upper surface on an outside of the upper case,
wherein at least one second elastic pad of the plurality of second elastic pads is surface-attached to a vehicle body or components connected to the vehicle body.

5. The high-voltage battery pack of claim 1, further comprising:
an outer side member placed in the lower case and coupled to a vehicle body; and
a plurality of third elastic pads disposed between the outer side member and end plates of the plurality of battery modules.

6. The high-voltage battery pack of claim 1, further comprising:
a plurality of first cross members coupled to the lower case and configured to extend forwards and rearwards; and
a plurality of second cross members coupled to the lower case and configured to extend leftwards and rightwards,
wherein the plurality of battery modules mounted on the lower case are configured to be connected to the plurality of first cross members and the plurality of second cross members.

7. The high-voltage battery pack of claim 6, further comprising:
a plurality of longitudinal members connecting second cross members of the plurality of second cross members, wherein the second cross members are disposed at a front periphery and a rear periphery of the lower case, and a front end and a rear end of the lower case, respectively.

8. The high-voltage battery pack of claim 7, wherein at least one longitudinal member of the plurality of longitudinal members is connected to end plates of the plurality of battery modules.

9. The high-voltage battery pack of claim 7, further comprising:
an outer side member placed in the lower case and coupled to a vehicle body,
wherein the outer side member, the plurality of first cross members, the plurality of second cross members, and the plurality of longitudinal members form a load path against an external impact.
